(19) United States
(12) Patent Application Publication
(10) Pub. No.: US 2016/0223649 A1
(43) Pub. Date: Aug. 4, 2016

(54) SYSTEMS AND METHODS FOR RADAR VERTICAL MISALIGNMENT DETECTION

(71) Applicant: Robert Bosch GmbH, Stuttgart (DE)

(72) Inventors: Oliver Schwindt, Palo Alto, CA (US); Kevin Buckner, Ann Arbor, MI (US); Bhavana Chakraborty, Novi, MI (US)

(21) Appl. No.: 14/609,808

(22) Filed: Jan. 30, 2015

(51) Int. Cl. G01S 7/40

(52) U.S. Cl. CPC G01S 7/4026; G01S 2007/4034

(57) ABSTRACT

Systems and methods for detecting vertical misalignment of a radar sensor mounted on a vehicle. One system includes a controller. The controller is configured to receive, from the radar sensor, a plurality of reflected radar signals from a target as one of the vehicle and the target moves and determine a plurality of data points, each of the plurality of data points corresponding to one of the plurality of reflected radar signals. The controller is also configured to determine a curve based on the plurality of data points, and determine a vertical alignment angle of the radar sensor by matching the curve to one of a plurality of pre-recorded curves and setting the vertical alignment angle of the radar sensor to an angle associated with the one of the plurality of pre-recorded curves.

### BACKGROUND

Embodiments of the present invention relate to systems and methods for detecting a vertical misalignment of a radar sensor mounted on a vehicle.

### SUMMARY

It is difficult to detect vertical misalignment of an automotive radar sensor. One reason for this is that the antennas of a set of radar sensors are in one line to give horizontal angular information. This antenna configuration provides no explicit information on reflections in the vertical direction. Adding extra antennas out of line with the other antennas or providing mechanically-operating scanning sensors with tilting mirrors increases the cost of a radar sensor.

Accordingly, embodiments of the present invention use only a horizontal radar beam to detect a vertical misalignment of a radar sensor.

In one embodiment, the invention provides a system for detecting vertical misalignment of a radar sensor mounted on a vehicle. The system includes a controller. The controller is configured to receive, from the radar sensor, a plurality of reflected radar signals from a target as one of the vehicle and the target moves and determine a plurality of data points, each of the plurality of data points corresponding to one of the plurality of reflected radar signals. The controller is also configured to determine a curve based on the plurality of data points, and determine a vertical alignment angle of the radar sensor by matching the curve to one of a plurality of pre-recorded curves and setting the vertical alignment angle of the radar sensor to an angle associated with the one of the plurality of pre-recorded curves. The controller can also be configured to compare the determined vertical alignment angle of the radar sensor to an operation range for the radar sensor and take corrective action if the angle is outside of the operation range.

In another embodiment, the invention provides a method for detecting vertical misalignment of a radar sensor mounted on a vehicle. The method includes receiving, from the radar sensor, a plurality of reflected radar signals from a target as one of the vehicle and the target moves and determining a plurality of data points, each of the plurality of data points corresponding to one of the plurality of reflected radar signals. The method also includes determining a curve based on the plurality of data points and determining a vertical alignment angle of the radar sensor by matching the curve to one of a plurality of pre-recorded curves and setting the vertical alignment angle of the radar sensor to an angle associated with the one of the plurality of pre-recorded curves. In addition, the method includes comparing the determined vertical alignment angle of the radar sensor to an operation range for the radar sensor, and, when the determined vertical alignment angle of the radar sensor is outside of the operation range, taking a corrective action to address misalignment of the radar sensor.

Other aspects of the invention will become apparent by consideration of the detailed description and accompanying drawings.

### BRIEF DESCRIPTION OF THE DRAWINGS

FIGS. 1a-d schematically illustrate a vehicle approaching and passing a target.

FIG. 2 schematically illustrates a controller included in the vehicle of FIG. 1.

FIG. 3 is a flow chart illustrating a method performed by the controller of FIG. 2 to determine a vertical alignment of a radar sensor.

FIG. 4 is a chart illustrating received power of a reflected radar signal associated with a vertically aligned sensor.

FIG. 5 is a chart illustrating received power of a reflected radar signal associated with a vertically misaligned sensor.

FIG. 6 is a chart illustrating a plurality of pre-recorded curves representing different alignment angles.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

It is also to be understood that while the term “sensor” implies a device that senses signals, as used herein, the term “sensor” includes devices capable of both transmitting and receiving or detecting signals, such as radar signals.

As noted above, embodiments of the invention determine a vertical alignment of a radar sensor. As described in more detail below, embodiments of the invention can use characteristics of reflected radar signals from a target to determine a vertical alignment of a radar sensor.

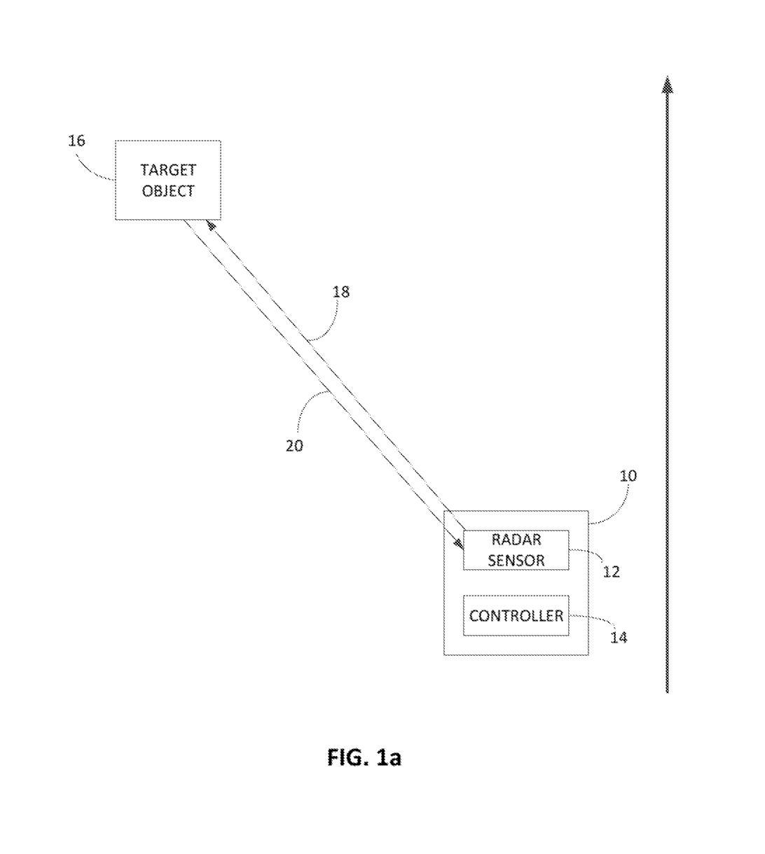

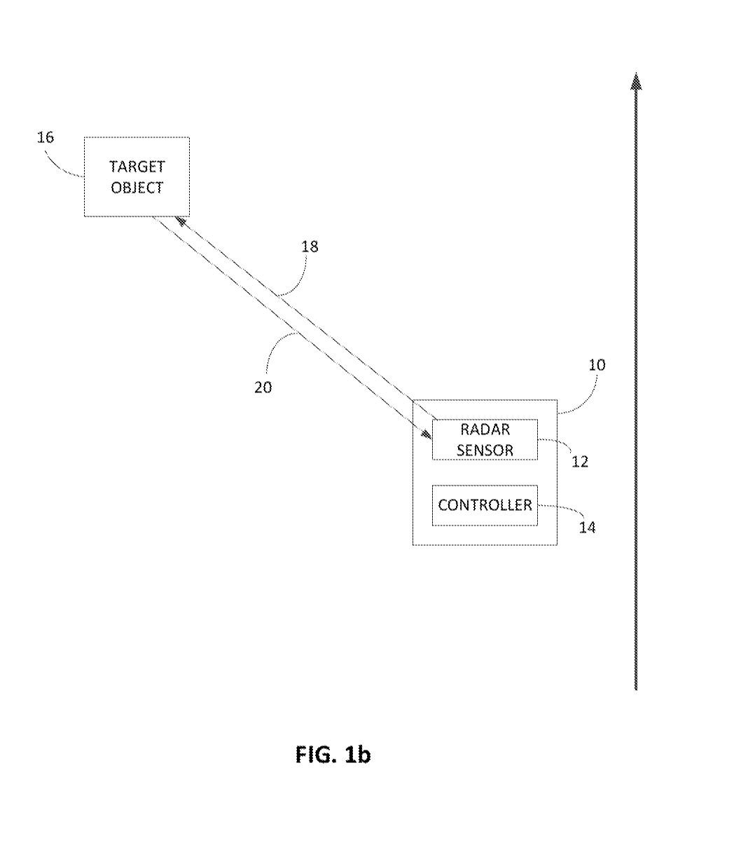

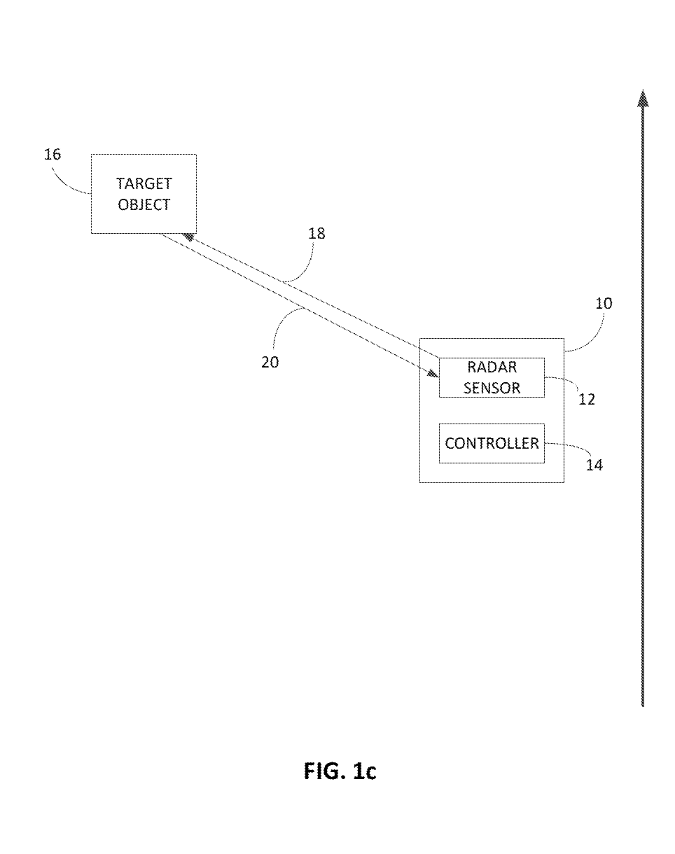

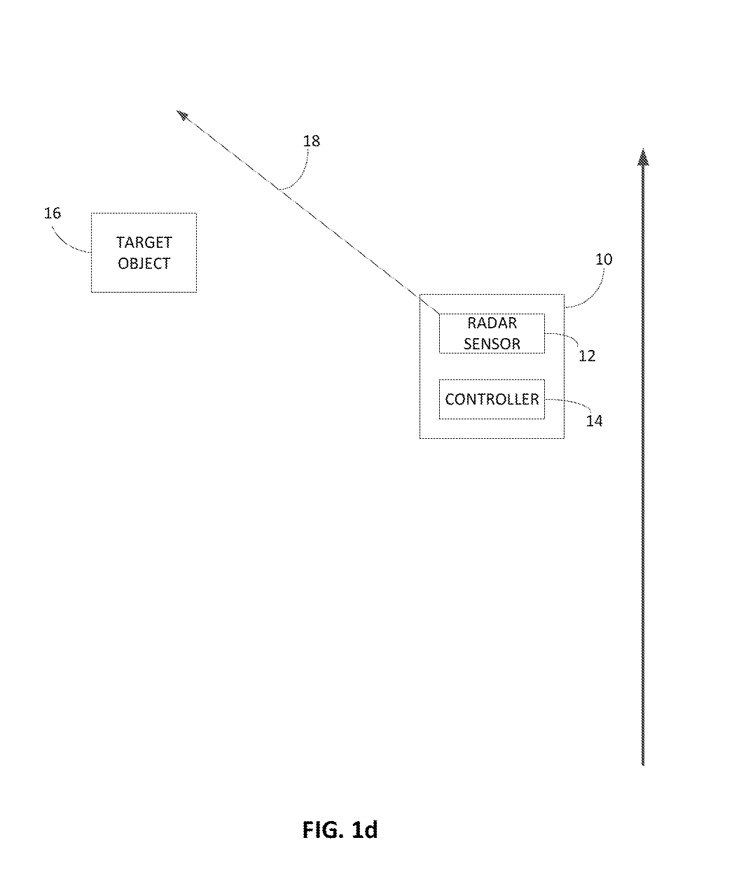

FIGS. 1a-d illustrate a vehicle 10 including a radar sensor 12 and a controller 14. As illustrated in FIGS. 1a-d, as the vehicle 10 moves, the vehicle 10 approaches a target 16. The target 16 represents any object that can be detected by the radar sensor 12. In some configurations, the radar sensor 12 is mounted on a front portion of the vehicle 10 and is configured to transmit radar signals 18. The transmitted radar signals 18 reflect from the target 16 and are received by the radar sensor 12 as reflected radar signals 20.

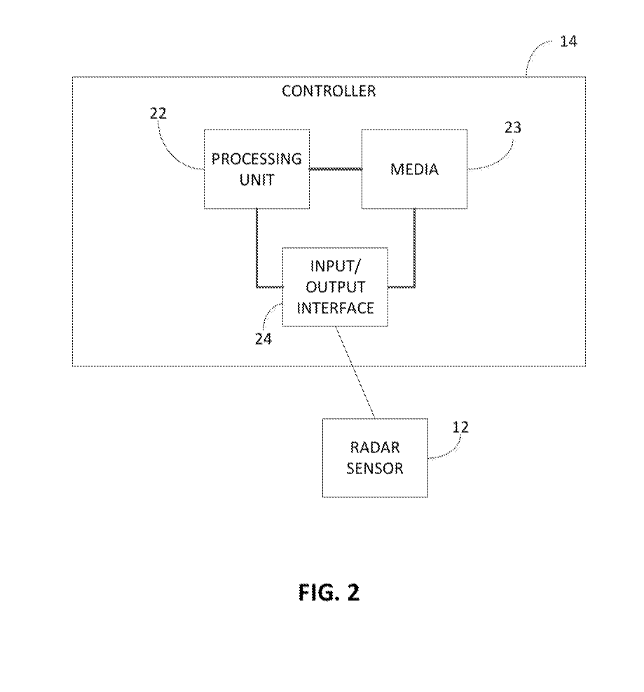

As illustrated in FIG. 2, the controller 14 includes a processing unit 22 (e.g., a microprocessor, application specific integrated circuit, etc.), non-transitory computer-readable media 23, and an input/output interface 24. The computer-readable media 23 can include random access memory (“RAM”) and/or read-only memory (“ROM”). The input/output interface 24 transmits and receives information from devices external to the controller 14, such as the radar sensor 12 (e.g., over one or more wired and/or wireless connections). The controller 14 can also use the input/output interface 24 to communicate with other controllers included in the vehicle 10, such as console or dashboard controller that provides information to a driver of the vehicle 10.

The processing unit 22 receives information (e.g., from the media 23 and/or the input/output interface 24) and processes the information by executing one or more instructions or modules. The instructions are stored in the computer-readable media 23. The processing unit 22 also stores information (e.g., information received through the input/output interface 24 and/or information generated by instructions or modules executed by the processing unit 22) to the media 23. It should be understood that although only a single processing unit, input/output interface, and computer-readable media module are illustrated in FIG. 2, the controller 14 can include multiple processing units, memory modules, and/or input/output interfaces.

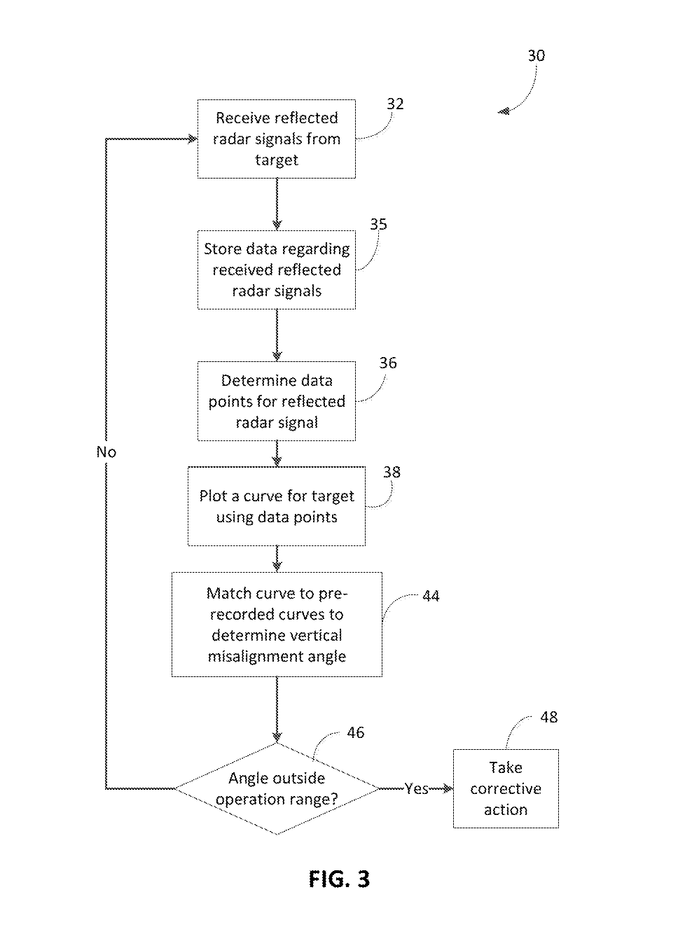

The instructions stored in the computer-readable media 23 provide particular functionality when executed by the processing unit 22. In general, the instructions use reflected radar signals from the target 16 to determine a vertical alignment of a radar sensor 12. For example, FIG. 3 illustrates a method 30 performed by the controller 14 to determine a vertical alignment for the radar sensor 12.

As illustrated in FIG. 3, the radar sensor 12 receives reflected radar signals from the target 16, which are provided to the controller 14 (at block 32). For example, returning to FIGS. 1a-c, as the vehicle 10 approaches the target 16, the radar sensor 12 emits a radar signal 18 and receives a reflected radar signal 20. As the vehicle 10 passes the target 16 (see FIG. 1d), the radar signal 18 emitted by the radar sensor 12 no longer reaches the target 16 and, therefore, no corresponding reflected signal 20 is received by the radar sensor 12. In some embodiments, as the vehicle 10 approaches and drives past the target 16, a first reflected radar signal 20 associated with the target 16 has a horizontal angle of approximately zero degrees (this may vary in curves or for non-stationary objects) and the horizontal angle of reflected radar signals 20 associated with the target 16 increases until the target 16 is out of the field-of-view of the radar sensor 12 when the vehicle 10 passes target 16.

For each reflected radar signal 20, the controller 14 stores data regarding the signal 20 (e.g., to the computer-readable media 23) (at block 35), which the controller 14 uses to determine one or more data points for the signal 20 (at block 36). For example, in some embodiments, the controller 14 stores a compensated received power level and a horizontal angle for each reflected radar signal 20. The compensated received power is the power that an antenna included in a radar sensor 12 receives for a reflected signal 20 with the distance-dependency and the effect of the antenna gain removed, which allows the reflected radar signals 20 to appear as if the target 16 is consistently positioned in directly in front of the vehicle 10 (e.g., at a zero degree horizon).

For example, the compensated received power (P_{r,comp}) can be measured in dB and can be calculated using the following equation:

$${P}_{r} = \frac{{P}_{t} {G}^{2} {λ}^{2} {σ}^{2}}{{R}^{4} 4 {π}^{3}}$$

where Pᵣ is the received power of the reflected radar signal 20, G is the antenna gain, λ is the wavelength of the reflected radar signal 20, σ is the radar cross section of the target 16, and R is the range of the radar sensor 12. Based on the above equation, the compensated received power is proportional to the radar cross section of the target 16: P_{r,comp} ∝σ²

To compensate the effects of the distance term R⁴ and the antenna gain G, the logarithm of both sides of the above equation can be taken. Thus, the above equation becomes:

P_{r,comp[dB]}=P_{r[dB]}−20 log(G(α))+40 log(R)+C

where C is a constant for the target 16. The constant C can be determined based on the properties of the target 16 (e.g., the radar cross section), the wavelength, and internal losses for transmitting and receiving radar signals from the radar sensor 12. As explained below, the method 30 tracks changes in compensated received power as compared to actual values. Accordingly, the change in the value of compensated received power values remains the same regardless of the value of C as long as C is a constant.

The equations above assume that the radar cross section (σ) of all detected targets 16 is the same (at least on average) even if the view angle is changed. For an ideal reflector, this would normally provide the same compensated received power for a target 16 no matter how far away or at what angle the target is detected, and the magnitude of the compensated received power would be proportional to the radar cross section of the target 16. In some embodiments, all targets 16 are approximated as being point-like in the vertical direction. However, real-world targets 16 may not be point-like in the vertical direction. Accordingly, the method 30 can compensate for this assumption by restricting evaluation to targets 16 located beyond a predetermined distance from the vehicle 10, where a height dimension of the target 16 is spread over a small angular range and, thus, makes the point-like assumption more value. Imposing this restriction can improve the resolution of the vertical alignment determined using the method 30.

As noted above, the controller 14 uses the stored data regarding the reflected radar signals 20 to establish data points (at block 36). For example, in some embodiments, the controller 14 uses the stored received compensated power and horizontal angles for each reflected radar signal 20 received from a target 16 as data points. The controller 14 can be configured to categorize (e.g., assign to a bin) the data points according to the value of the horizontal angle (e.g., into bins or categories assigned 0.5 degree increments). It should be understood that categorizing the data points is optional and may not be used in some embodiments. Also, in some embodiments, the controller 14 uses different values for the categories than degrees and the increments.

In some embodiments, a minimum range of angular values must be collected for the controller 14 to consider a target 16 significant for evaluation. Accordingly, the controller can be configured to count the number of different horizontal angles represented by the stored data points and can compare the count to a predetermined threshold prior to using the data points to plot a curve as described below.

The controller 14 can also be configured to normalize the data points for each target 16 so that changes in the received compensated power from various targets can be meaningfully compared. In some embodiments, the controller 14 normalizes the data by interpolating or extrapolating each data set to determine the compensated received power value for the horizontal angle of zero. The controller 14 can then divide all data points by this compensated received power value to generate a normalized data set (i.e., normalized data points). Once the data points are normalized, if more than one compensated received power value exists in a category, the controller 14 can average the values in the category.

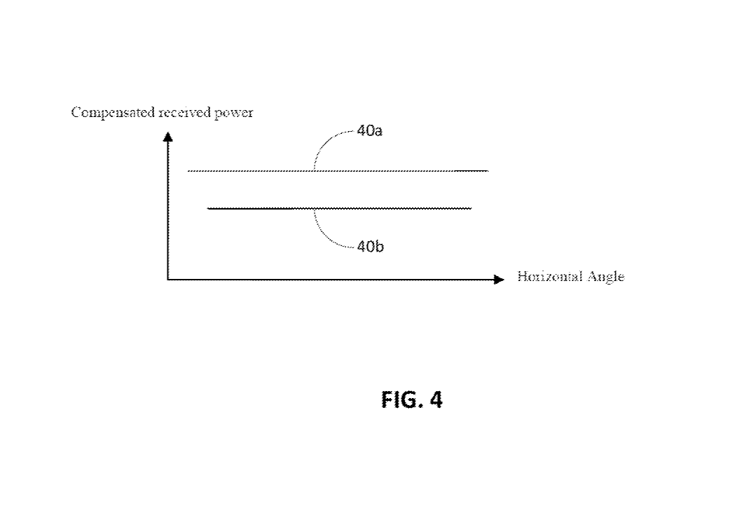

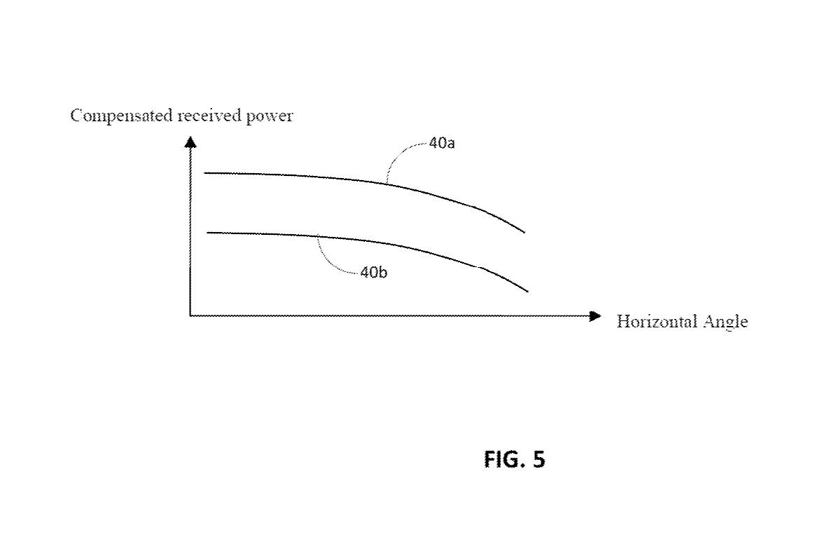

The controller 14 uses the data points to plot a curve (at block 38). For example, the controller 14 uses the data points (e.g., the normalized data points) to plot a compensated received power curve 40, as illustrated in FIGS. 4 and 5. Curves 40a illustrated in FIGS. 4 and 5 represent power curves associated with targets 16 with strong reflective characteristics, and curves 40b illustrated in FIGS. 4 and 5 represent power curves associated with targets 16 with weak reflective characteristics. The controller 14 then evaluates the compensated received power curve 40 to determine an alignment angle for the radar sensor 12. In particular, if a radar sensor 12 is vertically aligned, a constant compensated received power value is received for all angles, and the curve 40 is a straight line (see FIG. 4). However, if the radar sensor 12 is vertically misaligned, the compensated received power decreases as the horizontal angle increases, and the curve 40 is not straight (see FIG. 5).

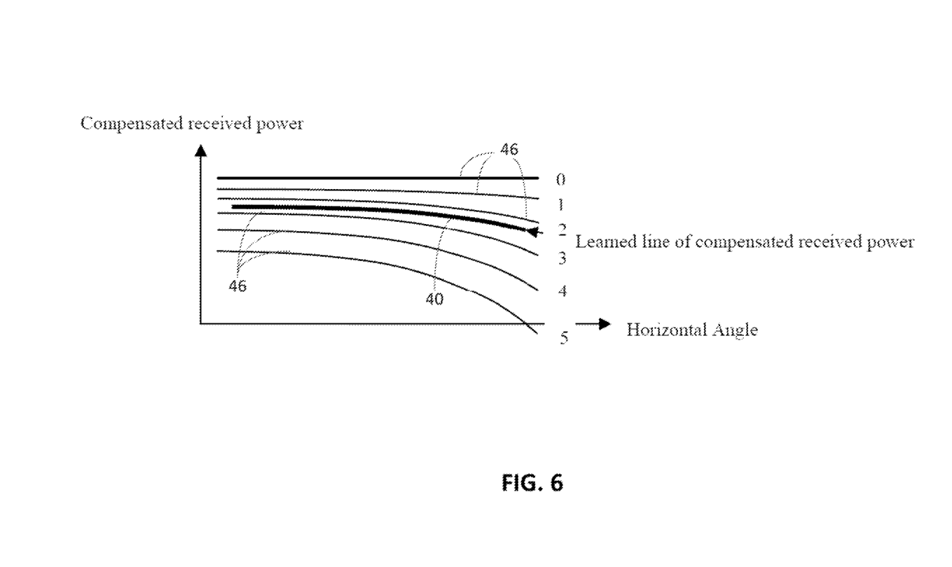

After plotting a power curve 40, the controller 14 compares the curve 40 to pre-recorded curves for vertically misaligned angles to identify a pre-recorded curve 26 that best fits the power curve 40 (at block 44). For example, the compensated received power curves for various vertical alignment angles (i.e., pre-recorded curves 46, see, e.g., FIG. 6) can be learned and stored in the radar sensor 12 and/or the controller 14 (e.g., in the computer-readable media 23). In some embodiments, pre-recorded curves 46 are stored for 0.5 degree increments from a − degree alignment (representing a preferred alignment of the radar sensor 12, which would be associated with a straight pre-recorded curve 46). The controller 14 can be configured to perform a least-squares match to find the best fit between a curve 40 and the pre-recorded curves 46. Accordingly, the pre-recorded curve 46 best matching a curve 40 identifies the alignment angle of a radar sensor 12. In some embodiments, the controller 14 collects compensated received power curves 40 from a quantity of targets 16 before determining an alignment angle for the radar sensor 12, such that individual targets 16 cannot play a significant role in determining the alignment of the radar sensor 12. Accordingly, the controller 14 can determine a best fit between each curve 40 and the pre-recorded curves 46 to identify multiple alignment angles of the radar sensor 12. The controller 14 can average or perform another type of mathematical calculation on the multiple angles to identify a single alignment angle of the radar sensor 12.

After identifying the alignment angle of the radar sensor 12 (at block 44), the controller 14 compares the alignment angle to an operation range associated with the radar sensor 12 (at block 46) (e.g., a range of alignment degrees that still provides normal or acceptable operation of the radar sensor 12 or a threshold alignment degree that indicates a maximum misalignment of the radar sensor 12 that still provides normal or acceptable operation). The operation range can be stored in the computer-readable media 23.

If the alignment angle is outside of the operation range (at block 46), the controller 14 determines that the radar sensor 12 is misaligned and takes a corrective action (at block 48). The corrective action can include setting an error condition, issuing a warning on a human machine interface (e.g., an interior console or dashboard), issuing a command to disable one or more vehicle systems that rely on the radar sensor 12, issuing a command to disable the radar sensor 12, or combinations thereof. For example, if the controller 14 determines that the radar sensor 12 is misaligned, other vehicle functions such as collision mitigation, adaptive cruise control, blind spot detection, closing vehicle warning, cross traffic alert, and autonomous driving may need to be disabled to prevent erroneous operation.

It should be noted that the pre-recorded curves 26 can be collected based on real-world measurements. For example, the reflection of radar signals off of the ground causes received power and horizontal angle values for a target 16 to differ from those for the same target 16 in free space. This distinction causes curves to differ for positive (pointing up) and negative (pointing down) alignment angles. If the pre-recorded curves 46 are collected using real-world measurements, the curves 46 can be used to distinguish between positive and negative alignments of the radar sensor 12. Accordingly, the determined vertical alignment angle for the radar sensor 12 can include both an angle and a direction (e.g., up or down), which aids correction of any misalignment.

The controller 14 can be configured to repeat the functionality described above to reliably determine an alignment angle (e.g., over the course of several minutes or a couple of hours). For example, each iteration of the method 30 can provide different results due to differences in the reflective characteristics of targets 16, differences in environment conditions, and combinations thereof. The differences can be minimized over time given a variety of detected targets 16. Also, as noted above, the controller 14 can repeat the method 30 to collect compensated received power curves for a sufficient number of targets 16 to ensure that no one target 16 plays a significant role in determining the alignment angle of the sensor 12. For example, the controller 14 can be configured to identify an alignment angle of the sensor 12 when a predetermined number of curves 40 exhibit the same vertical alignment angle when compared to the pre-recorded curves 46.

In some embodiments, the controller 14 can also be configured to deactivate vertical alignment detection when rain is detected (e.g., through use of the wipers or other detections) or when the radar sensor 12 is blind (e.g., to prevent errors due to rain, snow, or other water-films on the sensors 12).

The functionality described above can also be used to detect rotationally misaligned sensors by evaluating the left and right sides of a radar sensor 12 separately. For example, if the left side of a radar sensor 12 shows a positive alignment angle and while the right side shows a negative angle, the controller 14 can determine that the radar sensor 12 is rotated toward the right and can take appropriate corrective action.

It should be understood that the above alignment determination functionality can be used to determine a vertical alignment of a moving radar sensor 12 where the sensor 12 moves past a target 16 or a vertical alignment of a stationary radar sensor 12 where a target 16 moves past the sensor 12.

Thus, the invention provides, among other things, systems and methods for determining a vertical alignment in a radar sensor. Various features and advantages of the invention are set forth in the following claims.

What is claimed is:

1. A system for detecting vertical misalignment of a radar sensor mounted on a vehicle, the system comprising:
a controller configured to
(a) receive, from the radar sensor, a plurality of reflected radar signals from a target as one of the vehicle and the target moves,
(b) determine a plurality of data points, each of the plurality of data points corresponding to one of the plurality of reflected radar signals,
(c) determine a curve based on the plurality of data points,
(d) determine a vertical alignment angle of the radar sensor by matching the curve to one of a plurality of pre-recorded curves and setting the vertical alignment angle of the radar sensor to an angle associated with the one of the plurality of pre-recorded curves,
(e) compare the determined vertical alignment angle of the radar sensor to an operation range for the radar sensor, and
(f) when the determined vertical alignment angle of the radar sensor is outside of the operation range, take a corrective action to address misalignment of the radar sensor.

2. The system of claim 1, wherein each of the plurality of data points includes of a power level and a horizontal angle for one of the plurality of reflected radar signals.

3. The system of claim 2, wherein the power level is a compensated power level.

4. The system of claim 1, wherein the controller is further configured to normalize the plurality of data points.

5. The system of claim 1, wherein the controller is configured to determine the curve when a number of the plurality of data points exceeds a predetermined threshold.

6. The system of claim 1, wherein controller is configured to determine the curve based on the plurality of data points by categorize the plurality of data points based on a horizontal angle associated with each of the plurality of data points, average the data points included in each category to create a plurality of average data points, and determine the curve based on the plurality of average data points.

7. The system of claim 6, wherein the controller is configured to categorize the plurality of data points based on the horizontal angle associated with each of the plurality of data points by categorizing the plurality of data points into a plurality of categories, wherein each of the plurality of categories is associated with a horizontal angle in 0.5 degree increments.

8. The system of claim 1, wherein the controller is configured to determine the vertical alignment angle of the radar sensor by matching the curve to one of a plurality of pre-recorded curves by performing a least-squares match.

9. The system of claim 1, wherein the plurality of pre-recorded curves are based on real-world measurements.

10. The system of claim 1, wherein the vertical alignment angle indicates an angle and a direction.

11. The system of claim 1, wherein the controller is further configured to determine a plurality of curves by repeating (a)-(c) for each of a predetermined quantity of targets, and
determine a vertical alignment angle for each of the plurality of curves by matching each of the plurality of curves to one of the plurality of pre-recorded curves and setting the vertical alignment angle to an angle associated with one of the plurality of pre-recorded curves matching to a predetermined number of the plurality of curves.

12. The system of claim 1, wherein the controller is further configured to perform (a)-(c) to determine a first vertical alignment angle associated with a right side of the radar sensor and perform (a)-(c) to determine a second vertical alignment angle associated with a left side of the radar sensor and determine a rotational misalignment of the radar sensor based on the first vertical alignment angle and the second vertical alignment angle.

13. The system of claim 1, wherein the corrective action includes at least one action selected from the group consisting of setting an error condition, issuing a warning on a human machine interface, issuing a command to disable one or more vehicle systems that rely on the radar sensor, and issuing a command to disable the radar sensor.

14. A method for detecting vertical misalignment of a radar sensor mounted on a vehicle, the method comprising:
(a) receiving, from the radar sensor, a plurality of reflected radar signals from a target as one of the vehicle and the target moves;
(b) determining a plurality of data points, each of the plurality of data points corresponding to one of the plurality of reflected radar signals;
(c) determining a curve based on the plurality of data points;
(d) determining a vertical alignment angle of the radar sensor by matching the curve to one of a plurality of pre-recorded curves and setting the vertical alignment angle of the radar sensor to an angle associated with the one of the plurality of pre-recorded curves;
(e) comparing the determined vertical alignment angle of the radar sensor to an operation range for the radar sensor; and
(f) when the determined vertical alignment angle of the radar sensor is outside of the operation range, taking a corrective action to address misalignment of the radar sensor.

15. The method of claim 14, wherein determining the plurality of data points includes determining the plurality of data points based on a power level and a horizontal angle for each of the plurality of reflected radar signals.

16. The method of claim 15, wherein the power level is a compensated power level.

17. The method of claim 14, further comprising normalizing the plurality of data points.

18. The method of claim 14, further comprising
determining a plurality of curves by repeating (a)-(c) for each of a predetermined quantity of targets; and
determining a vertical alignment angle for each of the plurality of curves by matching each of the plurality of curves to one of the plurality of pre-recorded curves and setting the vertical alignment angle to an angle associated with one of the plurality of pre-recorded curves matching to a predetermined number of the plurality of curves.

19. The method of claim 14, wherein the corrective action includes at least one action selected from the group consisting of setting an error condition, issuing a warning on a human machine interface, issuing a command to disable one or more vehicle systems that rely on the radar sensor, and issuing a command to disable the radar sensor.
